(19) United States
(12) Patent Application Publication
(10) Pub. No.: US 2007/0104619 A1
(43) Pub. Date: May 10, 2007

(54) Reaction apparatus

(75) Inventors: Tohru Ishibashi, Tokyo (JP); Yasuyuki Numajiri, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/593,613

(22) Filed: Nov. 7, 2006

(30) Foreign Application Priority Data
Nov. 10, 2005 (JP) 2005-326229

(51) Int. Cl. B01J 19/00

(52) U.S. Cl. 422/130

(57) ABSTRACT

A reaction apparatus having a reaction chamber adapted to contain a probe immobilizing carrier and a sample in a hermetically sealed condition comprises a pressure detecting means for detecting the pressure of the reaction chamber, a pressure applying means for applying pressure to the reaction chamber according to the pressure detected by the pressure detecting means and a feasibility judging means for judging the feasibility of the reaction environment of the reaction chamber according to the pressure detected by the pressure detecting means and the pressure applied by the pressure applying means.

### BACKGROUND OF THE INVENTION

1. Field of the Invention

This invention relates to a hybridization reaction apparatus for causing a probe and a target substance to react with each other.

2. Description of the Related Art

Gene analysis using test pieces such as micro-arrays and DNA chips has become popular in recent years.

Test pieces to be used with this technique comprise a substrate, which may be a glass slide or a silicon substrate, and a plurality of biomolecules anchored to the surface thereof and immobilized there as detectants to form a matrix on the surface thereof. Typically probes of nucleic acid are used as detectants on the test piece. A probe of nucleic acid is referred to as nucleic acid probe hereinafter.

Assume now that a DNA chip formed by immobilizing nucleic acid probes on a substrate and a specimen DNA provided with a fluorescent label are put under an appropriate reactive condition. If the specimen DNA contains a target substance (nucleic acid molecules in this instance) that can be hybridized with the nucleic acid probe, the fluorescent label is caught by the DNA chip by way of the target substance. Then, it is possible to identify the type of the specimen DNA that is hybridized with a nucleic acid probe by detecting the position where the fluorescent label is present on the test piece (see Japanese Patent Application Laid-Open No. H11-187900).

FIG. 4 of the accompanying drawings schematically illustrates a hybridization reaction that can be produced in the reaction chamber of a known reaction apparatus using a DNA chip. Liquid containing the specimen DNA is injected into the reaction chamber 103 that is provided with a DNA chip 108 by way of an injection port 104 and the specimen DNA is diffused onto the nucleic acid probes on the DNA chip 108. Subsequently, a hybridization reaction takes place as the temperature condition in the reaction chamber is adjusted appropriately. Thereafter, the fluorescent label is detected by appropriate means (not shown).

However, bubbles can be produced to adhere to the anchoring parts of some nucleic acid probes when liquid containing a specimen is injected into the reaction chamber as indicated by 110(c), 110(d) in FIG. 4. Bubbles can also be produced from the gas dissolved in the liquid when the temperature of the reaction chamber rises during the process of hybridization reaction to adhere to the anchoring parts of some nucleic acid probes. As bubbles that appear in the reaction chamber adhere to nucleic acid probes, the nucleic acid probes and the target substance can no longer react with each other because the bubbles interfere with the reaction. Then, as a result, while some nucleic acid probes arranged on the substrate react with the target substance, the other nucleic acid probes cannot react with the target substance. The net result is that it is no longer possible to realize a uniform hybridization reaction and carry out a test using a DNA chip properly.

With regard to this problem, Japanese Patent Application Laid-Open No. 2003-520972 discloses an apparatus for carrying out a nucleic acid hybridization reaction on the substrate layer having a large number of oligonucleotide binding sites of a substrate equipped with a gas permeable flexible cover for the purpose of eliminating bubbles from the reaction sites.

However, with the technique disclosed in the above-cited document, it is difficult to satisfactorily eliminate the bubbles produced in the reaction chamber. Thus, it has been difficult to dissolve the problem of bubbles that interfere with a hybridization reaction.

### SUMMARY OF THE INVENTION

In view of the above-identified problem, it is therefore an object of the present invention to provide a reaction apparatus that is structurally simple and can; eliminate the influence of bubbles on hybridization reactions. Another object of the present invention is to provide a reaction apparatus that can judge the feasibility of the reaction environment according to the quantity of gas in the reaction chamber thereof. Still another object of the present invention is to provide a method of measuring a target substance by means of such an apparatus.

In an aspect of the present invention, the above objects are achieved by providing a reaction apparatus having a reaction chamber adapted to contain a probe immobilizing carrier and a sample in a hermetically sealed condition, the apparatus comprising: a pressure detecting means for detecting a pressure of the reaction chamber; a pressure applying means for applying a pressure to the reaction chamber according to the pressure detected by the pressure detecting means; and a feasibility judging means for judging a feasibility of the reaction environment of the reaction chamber according to the pressure detected by the pressure detecting means and the pressure applied by the pressure applying means.

In another aspect of the present invention, there is provided a method of measuring a target substance by causing a sample to react with a probe immobilizing carrier arranged in a reaction chamber in order to detect the existence or non-existence of the target substance or the content of the target substance in the sample by means of a reaction apparatus according to the present invention.

For the purpose of the present invention, any probe immobilizing carrier where probes that can specifically be bound to a target substance are immobilized can be used without limitations. The present invention can find applications when either an antigen or an antibody operates as target substance and the other operates as probes and when either of two substances that can be specifically bound to each other (e.g., proteins) operates as target substance and the other operates as probes. The target substance and the probes are not necessarily limited to nucleic acid for the purpose of the present invention.

With a reaction apparatus according to the present invention, it is possible to judge the influence of bubbles produced in the reaction chamber that is provided with a probe immobilizing carrier on a hybridization reaction. Then, it is possible to determine if the reaction is to be carried out or not according to the judgment to realize a highly accurate and reliable test.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a schematic illustration of an example of the hybridization apparatus according to the present invention.

FIGS. 2A and 2B schematically illustrate an example of the reaction chamber of the hybridization apparatus of FIG. 1.

FIG. 3 schematically illustrates bubbles adhering to probes anchored onto a substrate and immobilized there.

FIG. 4 is a schematic cross sectional view of an example of the reaction chamber and bubbles produced in the reaction chamber.

FIG. 5 is a typical flowchart of the operation of a reaction apparatus according to the invention down to hybridization.

FIG. 6 is a schematic illustration of an exemplary detection system that can be used to detect a hybrid by means of a fluorescent label.

### DESCRIPTION OF THE EMBODIMENTS

Preferred embodiments of the present invention will now be described in detail in accordance with the accompanying drawings.

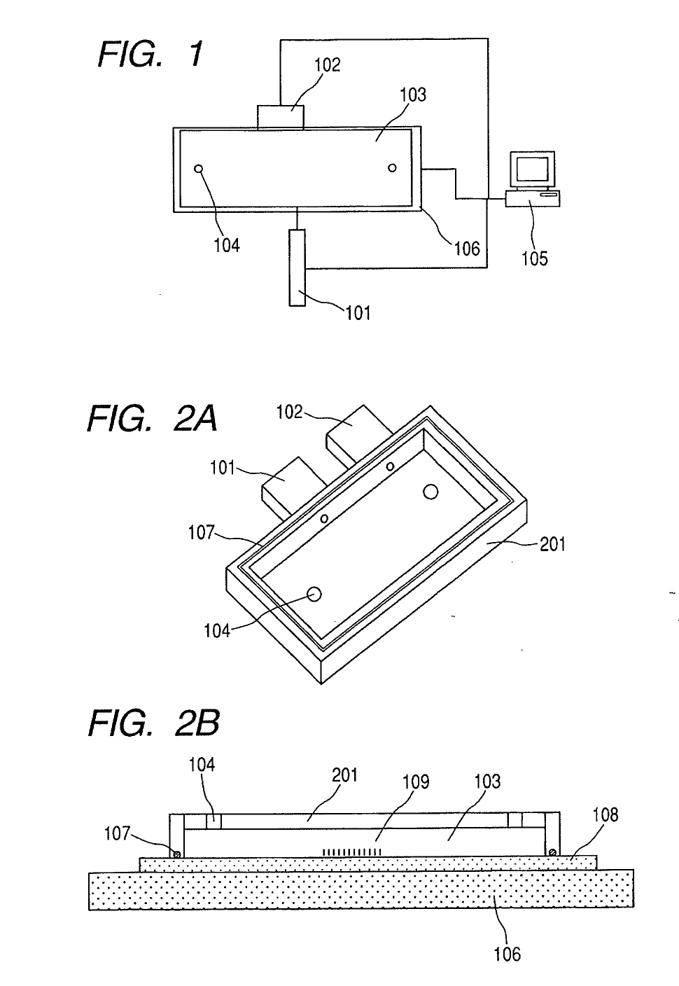

Unless specifically noted otherwise, the present invention will be described below in terms of hybridization apparatus adapted to use a DNA chip where oligonucleotide is immobilized on a substrate so as to operate as probes. FIG. 1 is a schematic illustration of a hybridization apparatus according to the present invention. FIG. 2A is a schematic perspective view of the reaction chamber of the hybridization apparatus of FIG. 1 as viewed from a position good for surveying the inner wall of the reaction chamber, showing a plate member and various devices connected to the plate member. FIG. 2B is a schematic cross sectional view taken along a plane perpendicular to the plate member to include the injection port and the discharge port arranged at the plate member. A pressurizing apparatus 101 such as a syringe pump and a pressure sensor 102 are connected to the reaction chamber 103 where a substrate is arranged and probes are anchored to and immobilized on the substrate. The substrate may typically be that of a DNA chip. The temperature of the reaction chamber can be regulated by means of a thermoregulator that comprises a heater and a Peltier element. The pressurizing apparatus, the pressure sensor and the thermoregulator are connected to a control section 105. The reaction chamber can be structurally hermetically sealed. A liquid sample containing a target substance is injected into the reaction chamber by way of the injection port 104 to fill the reaction ;chamber. The temperature of the reaction chamber is detected by a temperature detecting means (not shown) such as a temperature sensor and the internal temperature of the reaction chamber is regulated to a predetermined temperature (temperature range) by the thermoregulator 106 that operates as temperature regulating means according to the data obtained by the temperature detecting means. The internal pressure of the reaction chamber is detected by a pressure detecting means such as a pressure sensor and the internal pressure of the reaction chamber is regulated by adding pressure by means of a pressurizing apparatus 101 according to the data obtained by the pressure sensor. The heater and the cooling apparatus (not shown) for regulating the temperature are operated under the control of the control section 105. Similarly, the internal pressure of the reaction chamber is controlled by the control section 105.

The reaction chamber can typically be formed by the substrate of a DNA chip, an O-ring 107 that operates as bulkhead and the plate member 201. The plate member 201 may be provided with an injection port 104 for injecting the liquid sample, a pressure sensor 102, a flow channel linked to the pressuring apparatus 101 and, if necessary, another injection port for injecting washing liquid after the end of a hybridization reaction (not shown) (which may also be used as injection port for injecting a target substance) along with a discharge port.

When arranging the reaction chamber in the reaction apparatus, preferably the DNA chip 108 is made to reliably and tightly adhere to the O-ring and pressure is applied to the DNA chip and the plate member in order to prevent any leakage of liquid before heating the reaction chamber. Preferably, the reaction chamber is heated to a temperature level between 50° C. and 70° C. and left to the temperature level for 1 to 5 minutes, although such an operation may or may not be conducted and the temperature level and the time are by no means limited to the above-described respective ranges.

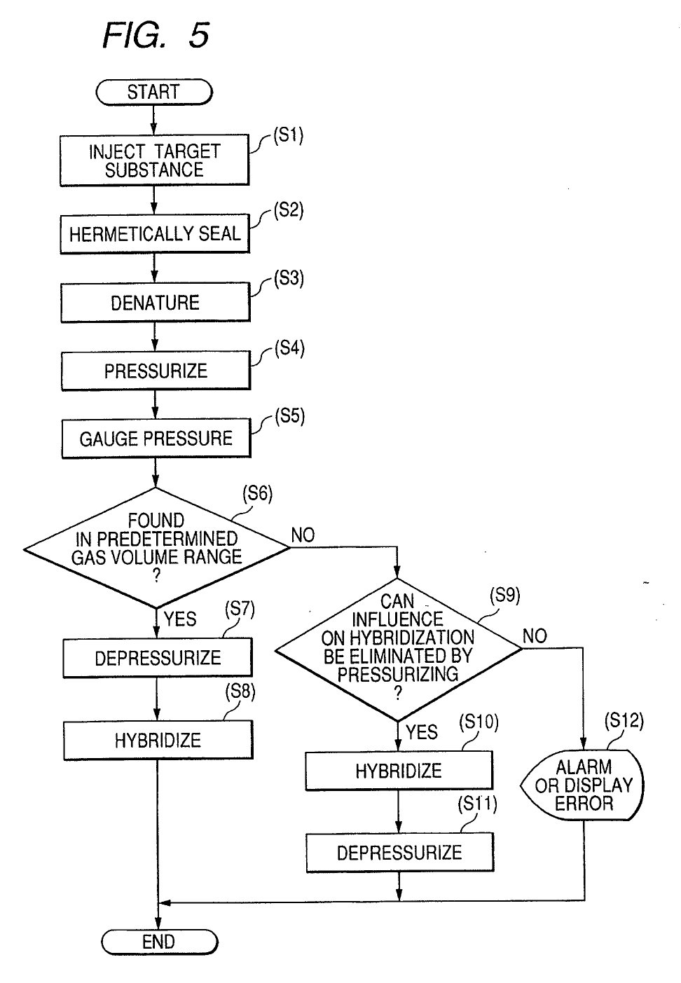

Now, the method of measuring the target substance by means of a reaction apparatus according to the present invention will be described below by referring to FIG. 5. Firstly, a fluorescent label is provided to the target substance. Then, the liquid sample containing the target substance is injected from the injection port (S1 in the flowchart of FIG. 5) and then the injection port and all the other open sections of the reaction chamber are closed to hermetically seal the reaction chamber (S2 in the flowchart of FIG. 5). If the target substance to be measured that is contained in the liquid sample is a double helix of DNA having two strands, no hybridization reaction takes place between the target substance and the DNA chip. Then, the target substance is not bound to the probe if the liquid sample is diffused in the reaction chamber and the condition for a hybridization reaction is regulated. Thus, it is preferable to denature the DNA and dissociate the two strands by raising the temperature of the reaction chamber (S3 in the flowchart of FIG. 5). Preferably, the reaction chamber is heated to a temperature level higher than the DNA melting temperature Tm, more specifically to a temperature range between about 80° and about 95° C., and the liquid sample is left there or agitated for 1 to 10 minutes. Note, however, it may or may not be necessary to denature the sample and the temperature and the time are by no means limited to the above-described respective ranges.

Then, the reaction chamber is brought to the temperature good for the hybridization reaction. While the temperature to be selected for the hybridization reaction may vary depending on the probes and/or the target substance, it is preferably between 30° C. and 60° C. Similarly, while the duration of the hybridization reaction may vary depending on the probe, the target substance and/or the concentration of the target substance in the liquid sample, it is preferably between 10 minutes and 24 hours.

If the target substance to be detected is a DNA containing a miss-matched base pair, it is preferable to raise the temperature of the reaction chamber to a relatively high level and select a relatively long hybridization time. Note, however, the conditions of a hybridization reaction are not limited to those listed above.

When conducting a denaturing process and a hybridization reaction and the temperature of the reaction chamber is raised, bubbles can appear out of the gas dissolved in the liquid sample that contains the target substance. Since bubbles can interfere with the hybridization reaction, it is preferable to denature the target substance at a place other than the inside of the reaction chamber if the denaturing process is to be conducted before the hybridization reaction. Additionally, the liquid sample is preferably injected into the reaction chamber that is deaerated by vacuum or by ultrasonic waves after the denaturing process.

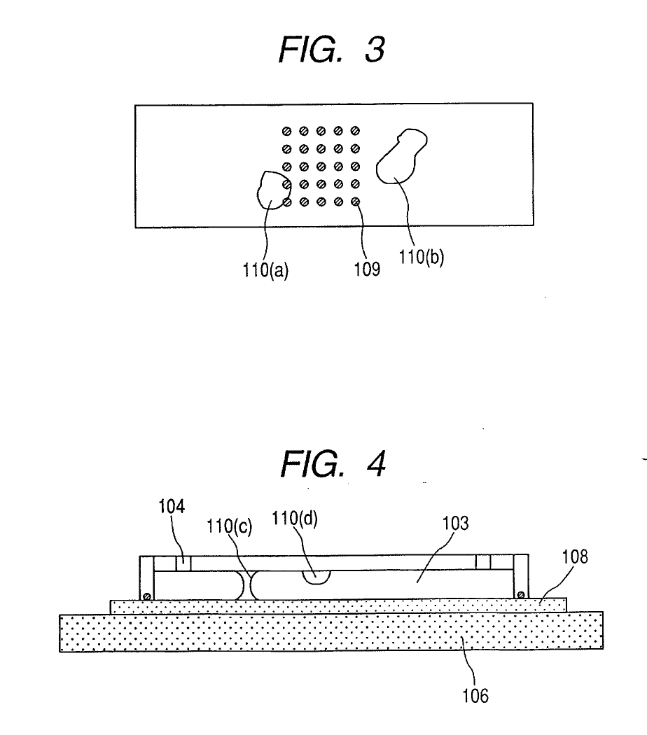

However, with such operations, it is difficult to completely eliminate the bubbles that appear in the reaction chamber. In addition to the bubbles that appear in the reaction chamber, the air that has entered the reaction chamber may not be completely discharged from the reaction chamber and partly remains there. FIG. 3 schematically illustrates bubbles adhering to probes anchored onto a substrate and immobilized there. The hybridization reaction does not develop properly if bubbles 100(a) adhere to some of the probes as shown in FIG. 3. Additionally, bubbles adhering to probes would not move away if the liquid sample is agitated to some extent. Thus, it is necessary to check if bubbles are found in the reaction chamber or not before conducting the hybridization reaction. In other words, it is necessary to judge the feasibility of the reaction environment in the reaction chamber.

According to the present invention, pressure is applied to the hermetically sealed reaction chamber and the volume of the bubbles therein is measured by utilizing the so-called vapor lock phenomenon. The pressure is raised when the volume is small and the hybridization reaction is conducted under a condition where bubbles are sufficiently downsized.

More specifically, the reaction apparatus is equipped with a syringe pump as pressurizing apparatus and the inside of the reaction chamber is pressurized by means of the pressuring apparatus while measuring the internal pressure by means of the pressure sensor. When the internal pressure gets to a predetermined level, the gas amount in the reaction chamber is computationally determined from the distance by which the syringe pump is driven to travel.

Assume that the cross sectional area of the syringe is d[mm²], the volume of the residual gas remaining in the channel connecting the syringe pump and the reaction chamber and in the part of the pressure sensor is x[mm³], the pressure gauged by the pressure sensor is p[atm] (p>1), the distance by which the syringe pump is driven to travel is L[mm] and the volume of the bubbles in the reaction chamber is v[mm³]. Then, the pressure p as observed by the pressure sensor is expressed as p=p₀+p′, where p₀ is the pressure as gauged by the pressure sensor before the pressurization and the pressure p′ applied by the pressurizing apparatus. Thus, the total sum of the change in the volume of the bubbles found in the reaction chamber and the residual gas is expressed by dL[mm³]. Therefore, the sum (total gas volume) of the volume x[mm³] of the residual gas and the volume V[mm³] of the bubbles is expressed by (x+V)/p[mm³] as it is reduced by the pressure applied from the syringe pump. Thus, the change in the volume is expressed by (p−1) (x+V)/p[mm³]. From above, it will be seen that the formula (1) shown below holds true.
dL=(p−1)(x+V)/p (1)

The ability of detecting bubbles found in the reaction chamber is higher when the distance by which the syringe is driven to travel is large. Therefore, the bubble detecting ability can be improved if the value of L can be increased. In other words, the bubble detecting ability is high when the cross sectional area of the syringe is small, the pressure is high and the residual gas volume is small.

For instance, if the volume of the residual gas remaining in the channel connecting the syringe pump and the reaction chamber and in the part of the pressure sensor is 39.25 mm³ and a syringe having a cross sectional area of 7.85 mm² is used, the distance by which the syringe is driven to travel is 4.5 mm to raise the pressure to 10 atm in a system where no bubbles are found in the reaction chamber. If observed at the time when a hybridization reaction is actually conducted, the volume V of bubbles is computationally determined to be 0 mm³ when the syringe pump is driven to travel by 4.6 mm and the pressure is raised to 12.5 atm. This result indicates that practically no bubbles are found in the reaction chamber. Then, the reaction environment is judged to be “good” in such a case and the temperature and the pressure in the reaction chamber are set respectively to appropriate levels to make the reaction develop (FIG. 5, S7 and S8). The depressurizing step S7 in FIG. 5 refers to an operation of returning the syringe pump to the initial position. As a result of this operation, the internal pressure of the reaction chamber restores the level before the pressurization by the syringe pump. When the operation of injecting the liquid sample is performed under the atmospheric pressure (1 [atm]), the internal pressure of the reaction chamber is reduced to the atmospheric pressure in the depressurizing step S7. While the internal pressure of the reaction chamber is not subjected to any limitations when the hybridization step S8 of FIG. 5 is executed, it is preferably set to the atmospheric pressure (1 atmosphere or its vicinity).

Now, a specific technique of analyzing the bubbles found in the reaction field when the present invention is used will be described below by way of an example where the syringe pump is driven to travel by 4.6 mm to make the internal pressure of the reaction chamber get to 10 atm. Then, bubbles are found in the reaction chamber to a volume of 0.87 mm³. In the reaction chamber illustrated in FIG. 4, if the thickness of the reaction chamber (the distance between the substrate that operates as the bottom section of the reaction chamber and the surface arranged vis-à-vis the substrate) is 500 μm and bubbles are assumed to show a perfectly cylindrical profile, the bubbles take an area of 1.74 mm² (when the influence of temperature to the volume or the pressure is negligible).

Bubbles having a diameter of 20 to 400 μm are produced at a rate of about 0.01 to 10/mm³, although the rate may vary depending on the physical properties of the liquid sample (e.g., viscosity and surface tension), those of the substrate (e.g., wettability), the dimensions of the reaction chamber, the denaturing temperature, the quantity of the dissolved gas and so on.

If 40 bubbles are produced in the entire reaction chamber, since the total gas volume is 0.87 mm³ as obtained from the above calculations, the volume and the half diameter of each bubble is 0.02175 mm³ and about 118 μm, respectively, in average.

The ink jet method, the pin method or some other known method may be used to apply the probe to the substrate. If the pin method is used, generally it is possible to form spots with a diameter of 100 to 250 μm. If the spot diameter is 100 μm, the size of a bubble exceeds that of a spot. Then, if bubbles are found on probes, the hybridization reaction will not proceed successfully.

Thus, it is possible to judge if the hybridization reaction is unsuccessful or not from the gas volume found in the reaction chamber by utilizing the present invention (S6 through S12 in the flowchart of FIG. 5).

More specifically, it is possible to make a judgment in a manner described below.

(A) The reaction environment is judged to be “good” when the gas amount in the reaction chamber is less than a predetermined reference level.

(B) The reaction environment is judged to be “improvable” when the gas amount in the reaction chamber exceeds the predetermined reference level but the reaction environment can be improved by pressurization.

(C) The reaction environment is judged to “not improvable” when the gas amount in the reaction chamber exceeds the predetermined reference level and the reaction environment cannot be improved by pressurization.

When the internal pressure of the reaction chamber is raised to 10 atm by the above-described technique, the volume of the bubbles in the reaction chamber is presumably compressed from 0.87 mm³ to 0.087 mm³. However, for each individual bubble adhering to the substrate, the compression ratio of the area where the bubble adheres before pressurization relative to after pressurization can be 1/10 and not 1/10^{2/3}. The latter value represents the situation of 110(d) in FIG. 4 while the former value represents the situation of 100(c) in FIG. 4. The situation of 110(d) does not interfere with the reaction between the probe and the target substance in a hybridization reaction.

On the other hand, if the contact area of the bubble is large in the situation of 110(c), it affects the hybridization reaction as described above. The volume of the bubble is reduced to 0.087 mm³ when the inside of the reaction chamber is pressurized to 10 atm. If all the bubbles in the reaction chamber are in the state of 100(c), the half diameter of each bubble is reduced to 1/10^{1/2}, or about 37.2 μm. Therefore, if bubbles are produced on spots with a spot diameter of 100 μm, the influence of bubbles on the hybridization reaction will be insiginificant. Thus, it is possible to minimize the influence of bubbles when the hybridization reaction is conducted while pressurizing the reaction chamber (S9 through S11 in the flowchart of FIG. 5).

When the probe immobilizing carrier and the specimen are made to react with each other under a pressurized condition, it is preferable to set the internal pressure of the reaction chamber to a level in a range between higher than 1 atm and not higher than 10 atm that can eliminate the influence of bubbles.

There may be occasions where bubbles are found in the reaction chamber to such an extent that the reaction environment cannot be improved and hence the influence of bubbles on the hybridization reaction cannot be eliminated if the reaction chamber is pressurized. To cope with such occasions, it is possible to give the alarm and/or display an error message for the purpose of suspending the progress of the reaction (S12 in the flowchart of FIG. 5). If necessary, it may be so arranged that a reaction is started and suspended automatically.

It is possible to automate a reaction by providing a predetermined reference for the volume of gas found in the reaction chamber or the distance by which the syringe is driven to travel and operating the control section 105 according to a program for executing the steps S1 through S12 illustrated in FIG. 5, using the reference. Such a program may be stored in the computer that operates as the control section 105 or recorded on a computer-readable medium so as to have the computer read it whenever necessary.

According to the present invention, it is also possible to examine the degree of hermetically sealed condition of the reaction chamber. More specifically, pressure is applied to a predetermined level and the internal pressure of the reaction chamber is gauged after the elapse of a predetermined time period. If a pressure fall is observed, it means that the reaction chamber is not hermitically sealed. Then, if the hybridization reaction is continued, the medium contained in the liquid sample can evaporate to change the concentration of the target substance and/or the medium itself can leak out from the reaction chamber. If such is the case, the hybridization reaction may be judged to be no good and suspended.

It is also preferable to provide the reaction apparatus with a functional feature of automatically detecting fluorescence after the completion of the hybridization reaction. For example, after the completion of the hybridization reaction, the unreacted liquid specimen may be washed with a buffer solution or water, dried and detected. The washing liquid may be substituted by liquid such as methanol or ethanol that can easily be volatilized and mixed with water to any desired ratio.

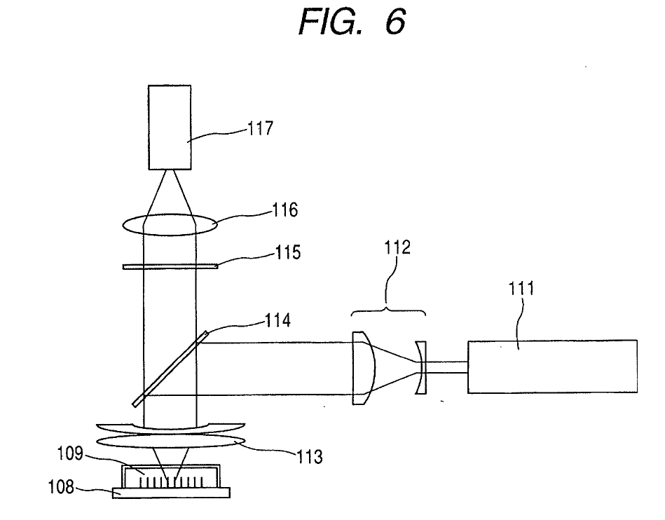

Fluorescence may be detected from the surface where the probes are anchored and immobilized (front surface) or from the rear surface. A method of detecting a hybrid by means of a fluorescent label will be described below by referring to FIG. 6. As shown in FIG. 6, a laser beam is output from a laser (laser beam source) 111 with a wavelength that matches the applied fluorescent label and the diameter of the laser beam is expanded by means of a beam expander 112. Then, the laser beam is reflected by a dichroic mirror 114. The dichroic mirror can be selected as showing appropriate transmission characteristics and reflection characteristics according to the type of fluorescent pigment that operates as fluorescent label.

A dichroic mirror 114 can operate as galvanomirror and reflect a laser beam to a desired position on a DNA chip for reading information from there. Then, the laser beam is condensed by means of an fθ lens 113 and fluorescence is generated when the target substance labeled by the fluorescent pigment is found at the position, or the spot, of the condensed laser beam. The fluorescence then passes the fθ lens 113, the dichroic mirror 114 and a band pass filter 115 and condensed by a condenser lens 116 before it enters a photoelectron multiplier 117. The signal detected by the photoelectron multiplier 117 is collected with other signals in a microcomputer (not shown). The signals are processed with positional information to show the intensity of fluorescence of each spot.

Examples of fluorescent pigments that can be used as fluorescent label to a specimen DNA include Cy3 with an excitation wavelength of 532 nm and Cy5 with an excitation wavelength of 633 nm.

The detection apparatus and the fluorescent label described above are only examples and the present invention is by no means limited thereto. While both the probes and the target substance are DNA and the reaction is a hybridization reaction in the above description, the present invention is by no means limited thereto. A reaction apparatus according to the present invention can find applications in the field of hybridization reactions other than DNA-DNA reactions, antigen-antibody reactions and enzyme activating reactions of probes and target substances.

The present invention is not limited to the above embodiments and various changes and modifications can be made within the spirit and scope of the present invention. Therefore, to apprise the public of the scope of the present invention, the following claims are made.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-326229, filed Nov. 10, 2005 which is hereby incorporated by reference herein in its entirety.

What is claimed is:

1. A reaction apparatus having a reaction chamber adapted to contain a probe immobilizing carrier and a sample in a hermetically sealed condition, the apparatus comprising:
pressure detecting means for detecting a pressure of the reaction chamber;
pressure applying means for applying a pressure to the reaction chamber according to the pressure detected by the pressure detecting means; and
feasibility judging means for judging a feasibility of the reaction environment of the reaction chamber according to the pressure detected by the pressure detecting means and the pressure applied by the pressure applying means.

2. The apparatus according to claim 1, wherein
the reaction apparatus further comprises gas amount calculating means for calculating an amount of gas found in the reaction chamber according to a change in total volume of the reaction chamber until the pressure applied by the pressure applying means gets to a specified pressure level.

3. The apparatus according to claim 2, wherein
the pressure applying means has a syringe pump and the amount of gas is calculated by means of formula (1) shown below and the distance by which the syringe of the syringe pump is driven to travel:
dL=(p−1)(x+V)/p (1),
where x is a volume [mm³] of gas remaining in the syringe pump and a pressure detecting section communicating with an inside of the reaction chamber, V is a volume [mm³] of gas contained in the reaction chamber, p is a predetermined pressure [atm], d is a cross sectional area [mm²] of the syringe pump and L is a distance [mm] by which the syringe of the syringe pump is driven to travel.

4. The apparatus according to claim 2, wherein
the feasibility judging means judges a level of reaction environment in a manner described below according to a first reference and a second reference defined by the volume of gas as calculated by the gas amount calculating means:
(A) The reaction environment is judged to be “good” when the gas volume in the reaction chamber is less than the predetermined first reference level,
(B) The reaction environment is judged to be “improvable” when the gas volume in the reaction chamber exceeds the predetermined first reference level but less than second reference level, and
(C) The reaction environment is judged to be “not improvable” when the gas volume in the reaction chamber exceeds the predetermined second reference level.

5. The apparatus according to claim 4, wherein
the internal pressure of the reaction chamber is set to be in a range not lower than 1 atm and not higher than 10 atm.

6. The apparatus according to claim 1, further comprising:
means for detecting the presence or absence of or the amount of a target substance reacted with the probes in the reaction chamber, provided that the sample contains the target substance that is apt to be bound with the probes.

7. The apparatus according to claim 1, further comprising:
means for exciting a fluorescent label and means for detecting fluorescence for the purpose of detecting a reaction of the probes and the target substance, utilizing the fluorescent label.

8. The apparatus according to claim 1, wherein
the reaction of the probes and the target substance is a hybridization reaction between nucleic acids.

9. The apparatus according to claim 1, wherein
the probe immobilizing carrier is a probe immobilizing carrier formed by arranging a large number of probes to a predetermined arrangement pattern.

10. A method of measuring a target substance by causing a sample to react with a probe immobilizing carrier arranged in a reaction chamber in order to detect the presence or absence of or the amount of a target substance in the sample by means of a reaction apparatus according to claim 1.
